(19) United States
(12) Patent Application Publication
(10) Pub. No.: US 2004/0233850 A1
(43) Pub. Date: Nov. 25, 2004

(54) Device and a method for determining routing paths in a communication network in the presence of selection attributes

(75) Inventors: Claire-Sabine Randriamasy, Meudon (FR); Jose Rui Figueira, Colos (PT); Xavier Gandibleux, Waterloo (BE); Philippe Thomin, Beuvrages (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/628,265

(22) Filed: Jul. 29, 2003

(30) Foreign Application Priority Data
Jul. 30, 2002 (FR) 02 09 660

(51) Int. Cl. H04L 12/26

(52) U.S. Cl. 370/238; 370/252

(57) ABSTRACT

A device (D) for determining data routing paths in a communication network including a multiplicity of nodes (Nn) includes processing means (M) adapted i) to ensure that at least a portion of said multiplicity of nodes are connected, ii) for said nodes of said portion, to calculate possible paths between a departure node and an arrival node, allowing for at least two chosen criteria, and then to deduce an ideal solution (Z( [symbol] )) from performances (Z(r*)) of said possible paths (r*) based on said criteria, iii) to assign each possible path a value of interest allowing for the ideal solution, and then to classify the possible paths allowing for their respective values of interest, and iv) to select from the classified possible paths the k best classified paths, in order to route data via one of said k paths.

The invention concerns the field of communication between terminals within a network, and more particularly that of determining data routing paths (or routes) between source and destination terminals.

Because of the exponential growth of traffic in public communication networks, such as the Internet, network operators are increasingly confronted with network congestion problems. This is the result, in particular, of the methods employed to determine data routing paths between network nodes. Traditional routing methods are not constrained and for most of them, based on determining the shortest path between the source and destination terminals, the greater part of the traffic is directed along the same path, which is therefore congested, while many other paths that might prove more suitable in the light of criteria other than the length, remain underused.

Moreover, the length of the routing path is not necessarily the most important criterion. Other criteria, for example the required bandwidth, can prove much more pertinent in some applications.

Several solutions to this problem have been envisaged. Thus it has been proposed to determine the routing paths using linear combinations of additive criteria. However, aggregating heterogeneous components with the aid of linear combinations is not truly meaningful and this approach provides a set of paths that does not necessarily contain the best path.

Two other solutions that have been proposed more recently attempt to improve the situation either for standard routing (also known as best effort routing), characterized by taking account of criteria in the absence of constraints, or for quality of service (QoS) routing, characterized by taking account of criteria in the presence of constraints.

A first solution concerns multiple criterion best effort routing and consists in calculating paths sequentially using additive criteria and then comparing them using additive and non-additive criteria. Because of the sequential processing, this solution requires a great deal of computation time. Moreover, this solution imposes the choice of a path from a set that does not necessarily contain the best path.

A second solution concerns multiple criterion QoS routing. This solution uses a tunable accuracy multiple constraints routing algorithm (TAMCRA) and consists in selecting at each intermediate node of the network the k shortest paths from a set of “non-dominated” paths. The criteria used in the calculation are all additive criteria, and each is constrained by an upper limit. The non-additive criteria, such as the bandwidth, are introduced in the form of constraints before starting the computation, with the aim of eliminating links between nodes that do not satisfy at least one of said constraints. This solution is described in particular in the paper by H. De Neve and P. Van Mieghem, “A Tunable Accuracy Multiple Constraints Routing Algorithm”, Computer Communication, Vol. 23, pages 667-670, 2000.

An improved version of the algorithm, called the self-adaptive multiple constraints routing algorithm (SAMCRA), is described in the paper “Hop-by-hop quality of service routing” by Piet Van Mieghem, Hans De Neve, and Fernando Kuipers, published in “Computer Networks”, vol.37, 2001.

As in the case of the first solution, the second solution (whether it uses the tunable accuracy multiple constraints routing algorithm TAMCRA or the improved version SAMCRA) cannot supply the best path because it does not take into account all the intermediate paths. Moreover, this solution can be applied only to QoS routing, given that the determination of paths is based on a comparison with thresholds, forming constraints, applied to criteria.

Thus neither prior art solution is entirely satisfactory, in particular with regard to taking account of the bandwidth criterion during the phase of determining routing paths and/or suitability for both best effort routing and QoS routing.

Thus an object of the invention is to remedy some or all of the drawbacks previously cited.

To this end, it proposes a method of determining data routing paths in a communication network including a multiplicity of nodes, which method includes the following steps:

a) ensuring that at least a portion of the multiplicity of nodes are connected,

b) for the nodes of said portion, calculating possible paths between a departure node and an arrival node, allowing for at least two chosen criteria, and then deducing an ideal solution from performances of the possible paths based on the criteria,

c) assigning each possible path a value of interest allowing for the ideal solution, and then classifying the possible paths allowing for their respective values of interest, and

d) selecting from the classified possible paths the k best classified paths, in order to route data via one of said k paths.

By definition, two nodes are “connected” if they can exchange data directly or indirectly via one or more other nodes. In other words, a graph of nodes is connected if each pair of nodes can be connected by a path.

The method according to the invention, which, in the basic mode defined hereinabove, can be used for best effort routing, can also be used for QoS routing. To this end step a) can begin by determining from the multiplicity of nodes all the pairs of nodes between which there can be established an oriented link supporting all the chosen local constraints, and then to assure the connectivity of all the nodes of these pairs. Instead of this, or in addition to this, at the end of step b), there can be retained from the possible paths those which satisfy all the chosen global constraints, so that in step c) values of interest are assigned to the possible paths retained.

In the present context, “local constraint” means a constraint applied to oriented links (or connections), such as arcs. Furthermore, in the present context “global constraint” means a constraint applied to a path, for example the number of hops on the path or the maximum duration of the path.

In the case of best effort routing, it is preferable to assure the connectivity of all of the nodes of the multiplicity of nodes, as the nodes concerned are not subject to selection beforehand, for example with the aid of local constraints.

At least one of the criteria used is preferably a non-additive criterion. In this case, it is advantageous to integrate into step b) a trace storing a route corresponding to a partial path, so as to detect and prevent cycles (or loops) in the paths under construction. It is even more advantageous, during the procedure of eliminating partial paths, to retain certain solutions referred to as solutions that are “weakly non-dominated” on the non-additive criterion.

The method according to the invention can have many additional features, and in particular, individually and/or in combination:

connectivity (which is a constraint) is preferably verified by a mechanism of propagation from the departure node to all the other nodes of the multiplicity of nodes, so that each node is visited; the Tarian algorithm can be used for this, for example;

in step b) representative values of its “performance” can be determined for each path with respect to each of the chosen criteria and a path for which the performance values are “non-dominated” then qualified as a possible path; in this case, still in step b), the best performance value observed over the possible paths, referred to as the “optimum value”, can be determined for each criterion and the ideal solution then constructed in the form of a multiplet of components constituted of the various optimum values thus determined; in fact, the links on which the optimum values are observed rarely constitute a connected sequence; in other words, an ideal path corresponding to an ideal solution exists only under exceptional circumstances;

in step c) the value of interest assigned to each possible path preferably characterizes the greatest value of the components associated with the various chosen criteria of a weighted Tchebychev function of differences between the performance of the path concerned and the corresponding component of the ideal solution. In this case, the k possible paths retained have the k lowest values of interest.

The invention also provides a device for determining data routing paths in a communication network including a multiplicity of nodes. The device is characterized in that it includes processing means adapted to:

a) ensure that at least a portion of the multiplicity of nodes are connected,

b) for the nodes of said portion, calculate possible paths between a departure node and an arrival node, allowing for at least two chosen criteria, and then deducing an ideal solution from performances of the possible paths based on said criteria,

c) assign each possible path a value of interest allowing for the ideal solution, and then classify the possible paths allowing for their respective values of interest, and

d) select from the classified possible paths the k best classified paths, in order to route data via one of said k paths.

The device according to the invention, which in the basic mode as defined hereinabove can be used for best effort routing, can also be used for QoS routing. To this end, the processing means can be adapted to begin by determining from the multiplicity of nodes all the pairs of nodes between which there can be established an oriented link supporting all the chosen local constraints, and then ensuring the connectivity of all the nodes in these pairs. Instead of this, or in addition to this, the processing means can be adapted to retain only possible paths that satisfy all of the chosen global constraints, in order to assign values of interest only to the possible paths retained.

If at least one of the criteria used is a non-additive criterion, it is advantageous for the processing means to be adapted to integrate into the calculation of the possible paths a trace storing a route corresponding to a partial path, in order to detect and prevent cycles in the paths under construction. It is even more advantageous if, during the procedure for eliminating partial paths, the processing means are able to retain certain solutions referred to as “weakly non-dominated” on the non-additive criterion.

The processing means of the device according to the invention can have many additional features, and in particular, individually and/or in combination, can:

verify connectivity by a mechanism of propagation from the departure node to all the other nodes of the multiplicity of nodes, so that each node is visited (or tested);

determine representative values of its “performance” for each path during the calculation of the possible paths, with respect to each of the chosen criteria and to qualify as a possible path a path for which the performance values are “non-dominated”. In this case, the treatment means can be adapted to determine the best performance value observed over the possible paths, referred to as the “optimum value”, for each criterion, and then to construct the ideal solution in the form of a multiplet of components constituted of the various optimum values thus determined;

assign to each possible path a value of interest that preferably characterizes the greatest value of the components associated with the various chosen criteria of a weighted Tchebychev function of differences between the performance of the possible path and the corresponding optimum value of the ideal solution; in this case the k possible paths retained have the k lowest values of interest.

In the method or the device according to the invention, it is preferable if:

any local and/or global constraints are selected from a group comprising at least the minimum bandwidth required, the maximum length of the path, the number of hops on the path, the maximum duration of the path, at least one prohibited link, the maximum number of hops on the path, and a path color restriction;

the criteria are selected from a group comprising at least the available bandwidth, the number of hops on the path, and the duration of the path; in this case it is even more preferable if the two chosen criteria comprise the available bandwidth and the duration of the path; during step b) (or using the processing means) the criterion relating to the duration of the path is advantageously impacted (or weighted) by a penalty that applies to the administration cost of the path, for example;

the criteria are chosen as a function of the type of service required;

the chosen criteria are weighted as a function of their importance in the light of management information;

any constraints and their associated values are chosen as a function of the quality of service required.

The invention can be used in IP communication networks.

Other features and advantages of the invention will become apparent on reading the following detailed description and examining the appended drawings, in which:

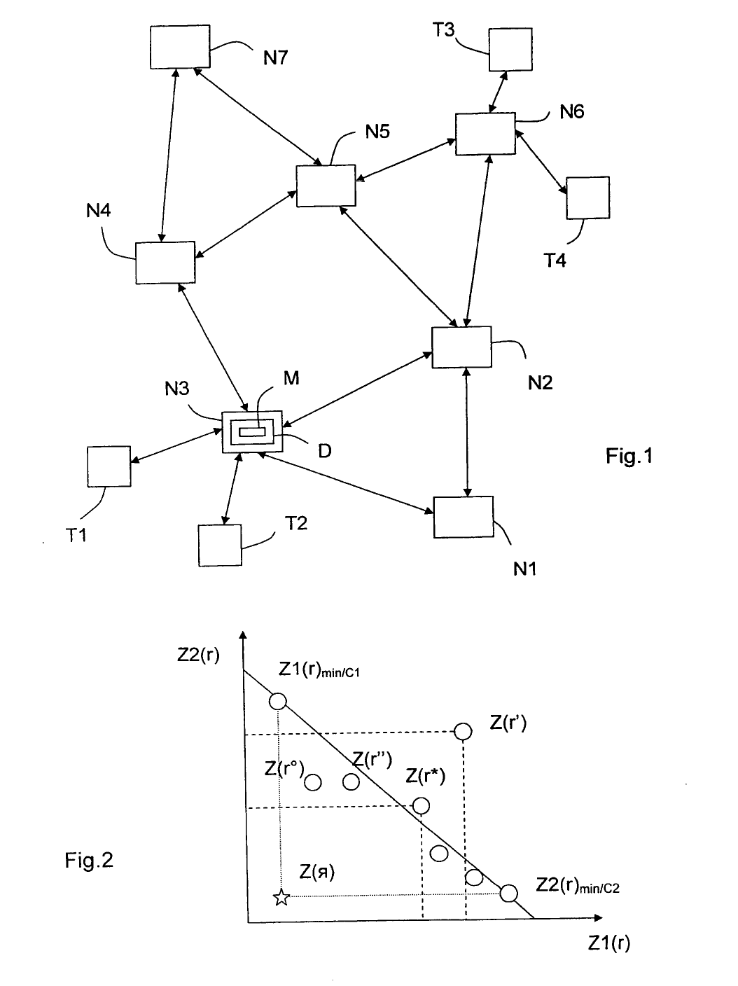

FIG. 1 shows diagrammatically part of a communication network including a multiplicity of nodes equipped with a device in accordance with the invention for calculating routing paths, and

FIG. 2 is a graph showing diagrammatically the method of determining “non-dominated” solutions.

The appended drawings are essentially of a definitive nature and consequently can serve not only to complete the description of the invention but also contribute to defining it, where appropriate.

As shown in FIG. 1, an IP communication network generally includes a multiplicity of switching or routing terminals Nn (in the present context n=1 to 7), also known as nodes, some of which are connected to user or company terminals Tm (in the present context m=1 to 4). If a user or company terminal Tm, called the source terminal, wishes to transmit data to one or more other user or company terminals, called destination terminals, it recovers the IP address or addresses of the destination terminal or terminals, after which the node Nn to which it is connected, using a path calculation module and the distributed routing protocol of the network, for example open shortest path first (OSPF), determines the path (or route) that is the best one for routing the data from the source terminal to the destination terminals. Each node of an IP network includes a path computation module which determines the next hop, i.e. the next adjacent node to which it must transmit the data packets, which are therefore routed step by step.

In the present context “path” means an ordered series of nodes or links (between two nodes i and j). Of course, a path can be modified during the transfer of data, for example to take account of a hardware problem. Consequently, all the nodes Nn of a network are generally able to compute a routing path conforming to the distributed routing protocol of the network.

In the remainder of the description the communication network is an IP network.

The device according to the invention is a routing path computation module. It is therefore intended to be installed in each node Nn of a communication network and to compute the path best suited to transmitting data between a source terminal and one or more destination terminals. It can additionally be coupled to a routing protocol, such as the OSPF link status routing protocol, provided that the protocol supports Traffic Engineering—Link State Advertisement (TE-LSA) traffic management.

The device D according to the invention is adapted to compute multiple criterion routing paths with or without constraints. It is therefore suitable for best effort routing and for QoS routing.

The device D includes a processing module M which can be implemented in the form of electronic circuits, software (or data processing) modules, or a combination of circuits and software. The processing module M can access information on the network utilization status, via the TE-LSAs, and the topology of the network, and consequently the list of its nodes Nn, which is generally stored in a memory of the node in which it is installed, which memory is regularly updated.

The remainder of the description relates to one embodiment of a device according to the invention suitable for QoS routing that is characterized by taking account of criteria in the presence of local and/or global constraints. However, as previously mentioned, the device is also suitable for basic (best effort) routing, which is characterized by taking account of criteria in the absence of constraints.

When the processing module M receives a path computation request, it starts by obtaining the topology and the utilization status of the network, in order to determine all the pairs of nodes that can set up a connection between them (referred to as a link and defined by a pair (i,i) designating two nodes) supporting each chosen local constraint.

In the present context “local constraint” means any constraint applicable to an oriented link of a network, such as an arc, and in particular the minimum bandwidth required, the maximum length of a link, the maximum duration of a link, and one or more prohibited links.

In best effort routing, this initial processing is naturally omitted, as constraints are not used.

The pairs of nodes are preferably determined from a filter graph G(X,U), where X represents the set of nodes Nn of the network and U the set of directional connections (links) denoted (i,j). All connections of the graph G(X,U) that violate at least one of the chosen local constraints are eliminated from the graph, which produces a “filtered” graph.

The processing module M then assures that the filtered graph G(X,U) is connected (in the mathematical sense). For this it preferably uses a technique of propagation of information from the source node Ns to all of the filtered graph nodes Nn, so that all the nodes are verified (tested). This verification of the connectivity of the graph can use the Tarion algorithm, for example.

In the case of best effort routing, verification of connectivity over at least a portion of the nodes of the graph, but preferably over all the nodes of the graph, constitutes the start of processing.

If the filtered graph (or the non-filtered graph in the case of best effort routing) is not connected, the remainder of the processing cannot be effected.

If the filtered (or non-filtered) graph is connected, the processing module M computes from the nodes of the pairs (links) (i,j) retained all of the possible paths (also known as “efficient paths”) r* between a departure node, for example the node N3, to which the source terminal, for example the terminal T1, is connected, and an arrival node, for example the node N6, to which the destination terminal, for example the terminal T3, is connected, taking into account at least two chosen criteria.

In the present context “possible path” means an “efficient” path or a “Pareto-optimal” path whose performance values (see below) are “non-dominated”. Moreover, in the present context “criterion” means any type of criterion (or metric) that can be taken into account in a network, whether it is additive, for example the duration of the path C1 or the number of hops on the path C3, or non-additive, for example the available bandwidth C2 (which is additionally of the “minimum-maximum” type). C1 and C2 are called “high-level” criteria, while C3 is called a “low-level” criterion. Consequently, the criteria C1 and C2 are preferably always taken into account, whereas the criterion C3 is optional.

It may be beneficial to impact (i.e. weight) the criterion C1 (path duration) by a penalty applying to the administration cost CA of the path, for example. This reduces the computation vectors (see below) by one dimension, and consequently limits the computation time and the memory capacity necessary for the computation.

A possible path r* is preferably computed as explained below. First of all, a path is designated by a variable r(s,t), in which s designates the source node and t the destination node, and by a performance vector Z(r) defined by a multiplet of components (Z1(r), Z2(r), . . . , Zp(r)) each associated with one of the p criteria used. For example, the component Z1(r) represents the performance of the path r in relation to the criterion C1 and the component Z2(r) represents the performance of the path r in relation to the criterion C2.

For an additive criterion, such as C1, the component Z1(r) of the performance Z(r) is defined by the equation

$$Z1 ( r ) = {\sum }_{( i , j ) ∈ r} C1 ( i , j ) .$$

When the criterion C1 is impacted (weighted) by the penalty CA, the preceding equation is written

$$Z1 ( r ) = {\sum }_{( i , j ) ∈ r} C1 ( i , j ) * C A ( i , j ) .$$

For a non-additive criterion, such as C2, the component Z2(r) of the performance Z(r) is defined by the equation Z2(r)=MIN_{(i,j)∈r}C2(i,j).

Here, Cp(i,j) designates the value of the criterion Cp for an arc (i,j).

Given the above definitions, a path is described as a possible path r*(s,t), i.e. an “efficient” path, if there is no path that can be envisaged between the nodes s and t satisfying the conditions Zp(r)≦Zp(r*), ∀p=1 to P (where P is the total number of criteria used), and Zp′(r)<Zp′(r*) for any of the components p belonging to the set {1, . . . ,P}.

The performance vector Z(r*) of the path r* is then referred to as a “non-dominated solution” (NDS) if every other path r′ has a performance vector Z(r′) of which at least one of the components Zp(r′) is “less good” (or “lower performing”) than the corresponding component Zp(r*) of the path r*. This kind of path r*, associated with a non-dominated performance vector, is then called a possible path (or “efficient path”) or a “Pareto-optimal” path.

FIG. 2 shows one example of non-dominated solution (NDS) determination, in the case of two criteria C1 and C2 that are commensurable, i.e. whose metrics have dimensions that can be added and multiplied. This applies equally to incommensurable magnitudes, such as the bandwidth C2. It also applies equally to sets of mutually incommensurable magnitudes, such as the duration of the path C1 and the bandwidth C2.

In this example, Z(r*) is a non-dominated solution (NDS), as there is no other point all of whose coordinates are less than those of Z(r*). Each other point Z(r) has at least one component that is less good than the corresponding component of Z(r*). In other words, the cone represented in dashed outline and below and to the left of Z(r*) is empty. In this example, Z(r′) is dominated by four points, including Z(r*), which are within the cone represented in dashed outline and below it, but by the extreme points Z1(r)_{min/C1}, associated with C1, and Z2(r)_{min/C2}, associated with C2, which are therefore also non-dominated. Here only Z(r′) is a dominated solution. Moreover, Z(r″) is a solution “weakly non-dominated” by Z(r^{o}) because at least one of the components of Z(r′) is equal to (and not less than) its counterpart in Z(r″).

In order to compute the various possible paths r* obtained by the method described above, it is possible to use an adaptation of a label assignment algorithm of the type described in the paper by E. Martins, “On a multi-criteria shortest path problem”, European Journal Of Operational Research, Vol. 16, pages 236-245, 1984.

The adaptation consists, in particular, in integrating into the additive criteria processed by the Martins algorithm a non-additive criterion, for example a “minimum-maximum” criterion. Integrating this kind of criterion entails adapting the algorithm, for example as explained below.

A first adaptation can consist in integrating into the path computation algorithm (corresponding to step b) of the method) a trace storing the route corresponding to a partial path, in order to detect and prevent cycles (or loops) in the paths under construction during execution of the algorithm.

A second adaptation, preferably combined with the first, can consist in retaining solutions that are weakly non-dominated on the “minimum-maximum” criterion during the partial path elimination procedure. For example, if three criteria C1, C2, C3 are considered of which the first two are additive and the third is of the “minimum-maximum” type, then the point z=(3, 2, 4) is dominated by the point z^{o}=(1, 1, 4) for the criteria C1 and C2 but weakly non-dominated for the criterion C3. The point z and the corresponding partial path are therefore retained. Thus all possible efficient paths can be considered. However, the solutions corresponding to the final efficient paths (produced in step b) of the method) are all non-dominated and not weakly non-dominated.

All the possible paths r* determined in this way are then stored in a memory of the device D (not shown), which guarantees that the best of them, in the light of the criteria and constraints used, has not been omitted.

The processing module M then forms an ideal solution Z( [symbol] ). To be more precise, the ideal solution Z( [symbol] ) is a vector taking the form of a multiplet of components.

The components are computed as follows. For each criterion Cp, the best performance value Z*p observed for the possible paths is extracted. Each observed best performance value Z*p is called the optimum value associated with the corresponding criterion. The various optimum values then constitute the components of the ideal solution Z( [symbol] )=(Z*1, Z*2, . . . , Z*p), representative of an ideal path [symbol] .

It is important to note that the ideal path [symbol] represented by the ideal solution Z( [symbol] ) does not necessarily correspond to one of the possible paths r* of the set of possible paths determined. In fact, this is rarely so, given that the links on which the optimum values are observed rarely constitute a connected sequence. Nevertheless, when this is the case, it constitutes the only possible path r*, because it dominates all the others.

The processing module M then submits the various possible paths to at least one chosen global constraint.

In the present context “global constraints” means constraints that can be applied to paths, as against local constraints that apply to the links between nodes.

These are, for example, the minimum bandwidth required, the maximum length of the path, the maximum number of hops on the path, and the maximum duration of the path.

The processing module M retains the possible paths r* that do not violate the global constraint or constraints used. In the case of best effort routing, this processing is omitted, of course.

The processing module M then assigns each possible path r* a value of interest (or “path value”) U(r) allowing for the ideal solution Z( [symbol] ).

To this end, a conventional scalarization function can be used, for example a weighted Tchebychev function of the differences between the components Zp(r) of the performance value Z(r) of the path concerned r and the corresponding components Zp( [symbol] ) representative of the ideal path [symbol] . This kind of function can take the form U(r)=MAX_{p=1 to P} {Wp(Zp(r)−Zp( [symbol] ))}, where Wp is a weighting coefficient of the criterion Cp chosen when configuring the device and enabling different relative weights to be assigned to the criteria, where necessary. This value of interest quantifies the performance difference between a possible path r* and the ideal path [symbol] , given the respective weights assigned to the various criteria used.

The processing module M then classifies the possible paths r* allowing for their respective values of interest U(r). With the definition of the value of interest U(r) given above, the possible paths are classified in increasing value of interest order, the lowest value of interest U(r) corresponding to the possible path r* most suitable for transferring the data, given the criteria and constraints used. The classification is therefore effected with respect to an ideal point implied by the data and not a comparison based on arbitrary values.

The k best classified paths are then selected from the classified possible paths, in order to route data via one of these k paths, and preferably that which is the best classified path (i.e. that with the lowest value of interest U(r) in the example described here). It is important to note that the number of paths found by the processing described hereinabove can be less than k, which is an integer from 1 to 5, for example.

The foregoing description refers to criteria and constraints (local and global), which in some cases might seem substantially identical. In fact, they can be considered as selection attributes that are sometimes manifested as criteria and sometimes as constraints, knowing that a criterion is generally the subject of maximization or minimization while a constraint is generally defined by one or two fixed or limiting values.

The selection attributes are defined by the network operator when configuring the network and depend on the type of service required, for example sending an email or requesting setting up of a videoconference, and/or the quality of service (QoS) required at the time of initial resource reservation. To be even more precise, the criteria are chosen as a function of the type of service required, whereas the constraints, and their values, are chosen as a function of the quality of service required.

The invention also provides a method of determining data routing paths in a communication network including a multiplicity of nodes.

This can be achieved using the device D described hereinabove. The main and optional functions and subfunctions provided by the steps of the method being substantially identical to those provided by the various means constituting the device D, only the steps implementing the main functions of the method according to the invention are summarized hereinafter.

The method is characterized by the following combination of steps:

a) ensuring that at least a portion of the multiplicity of nodes (Nn) are connected,

b) for the nodes of the portion, calculating possible paths (r*) between a departure node (Ns) and an arrival node (Nt), allowing for at least two chosen criteria, and then deducing an ideal solution (Z( [symbol] )) from performances (Z(r*)) of the possible paths (r*) based on the criteria,

c) assigning each possible path (r*) a value of interest (U(r)) allowing for the ideal solution (Z( [symbol] )), and then classifying the possible paths allowing for their respective values of interest, and

d) selecting from the classified possible paths the k best classified paths, in order to route data via one of the k paths.

To enable QoS routing, step a) can begin by determining from the multiplicity of nodes or pairs of nodes that can establish between them an oriented link supporting all the chosen local constraints, and then ensuring that all the nodes of these pairs are connected. Instead of this, or in addition to this, at the end of step b) it is possible to retain from the possible paths those that satisfy all the chosen global constraints, so that in step c) values of interest are assigned to the possible paths retained.

The invention is not limited to the embodiments of methods and devices described hereinabove by way of example only, but encompasses all variants within the scope of the following claims that the person skilled in the art might envisage.

Thus there is described above a QoS mode of operation that takes account of criteria (at least two criteria), at least one local constraint, and at least one-global constraint. Other modes of operation can be envisaged, however. Thus it is possible to envisage a simplified QoS mode of operation that takes account of criteria (at least two criteria) and at least one local constraint, with no global constraint. Another simplified QoS mode of operation can be envisaged in which account is taken of criteria (at least two criteria) and at least one global constraint, with no local constraint. Finally, as previously mentioned, a best effort mode of operation can be envisaged, taking account only of criteria (at least two criteria).

1. A method of determining data routing paths in a communication network including a multiplicity of nodes (Nn), which method is characterized in that it includes the following steps:
a) ensuring that at least a portion of said multiplicity of nodes (Nn) are connected,
b) for said nodes of said portion, calculating possible paths (r*) between a departure node (Ns) and an arrival node (Nt), allowing for at least two chosen criteria, and then deducing an ideal solution (Z( [symbol] )) from performances (Z(r*)) of said possible paths (r*) based on said criteria,
c) assigning each possible path (r*) a value of interest (U(r)) allowing for said ideal solution (Z( [symbol] )), and then classifying said possible paths allowing for their respective values of interest, and
d) selecting from said classified possible paths the k best classified paths, in order to route data via one of said k paths.

2. A method according to claim 1, characterized in that step a) begins by determining from said multiplicity of nodes (Nn) all the pairs of nodes that can establish between them an oriented link each supporting at least one chosen local constraint, after which it is ensured that all the nodes of said pairs are connected.

3. A method according to claim 1, characterized in that at the end of step b) there are retained from said possible paths (r*) those that each satisfy at least one chosen global constraint so that in step c) values of interest (U(r)) are assigned to said retained possible paths (r*).

4. A method according to claim 1, characterized in that at least one of said criteria is of the non-additive type.

5. A method according to claim 4, characterized in that step b) integrates a trace storing a route corresponding to a partial path, in order to detect and prevent cycles in the paths under construction.

6. A method according to claim 5, characterized in that in step b), during the procedure of eliminating said partial paths, there are retained solutions that are “weakly non-dominated” on the non-additive criterion.

7. A method according to claim 1, characterized in that connectivity is verified by a mechanism of propagation from the departure node (Ns) to all the other nodes (Nn) of said multiplicity of nodes, so that each node (Nn) is visited.

8. A method according to claim 1, characterized in that in step b) representative values (Z(r)) of its “performance” are determined for each path with respect to each of said chosen criteria and a path (r) for which said performance values (Z(r)) are “non-dominated” is qualified as a possible path (r*).

9. A method according to claim 8, characterized in that in step b) the best performance value (Z*(r)) observed over said possible paths, referred to as the “optimum value”, is determined for each criterion and said ideal solution (Z( [symbol] )) is then constructed in the form of a multiplet of components constituted of the various optimum values thus determined.

10. A method according to claim 9, characterized in that in step c) said value of interest (U(r)) assigned to each possible path (r) characterizes the greatest value of the components associated with the various chosen criteria of a weighted Tchebychev function of differences between the performance of said possible path (r*) and the corresponding optimum value of said ideal solution (Z( [symbol] )).

11. A method according to claim 10, characterized in that said k possible paths retained have the k lowest values of interest (U(r)).

12. A method according to claim 2, characterized in that said local and/or global constraints are selected from a group comprising at least the minimum bandwidth required, the maximum length of the path, the maximum duration of the path, at least one prohibited link, the maximum number of hops on the path, and a path color restriction.

13. A method according to claim 1, characterized in that said criteria are selected from a group comprising at least the available bandwidth (C2), the number of hops on the path (C3), and the duration of the path (C1).

14. A method according to claim 13, characterized in that said chosen criteria used in step b) comprise the available bandwidth (C2) and the duration of the path (C1).

15. A method according to claim 14, characterized in that in step b) said criterion relating to the duration of the path (C1) is impacted by a penalty.

16. A method according to claim 15, characterized in that said penalty applies to the administration cost (CA) of the path.

17. A method according to claim 1, characterized in that said criteria are chosen as a function of the type of service required.

18. A method according to claim 1, characterized in that said chosen criteria are weighted as a function of their importance in the light of management information.

19. A method according to claim 2, characterized in that said constraints and their associated values are chosen as a function of the quality of service required.

20. A device for determining data routing paths (D) in a communication network including a multiplicity of nodes (Nn), which device is characterized in that it includes processing means (M) adapted to:
a) ensure that at least a portion of said multiplicity of nodes (Nn) are connected,
b) for said nodes of said portion, calculate possible paths (r*) between a departure node (Ns) and an arrival node (Nt), allowing for at least two chosen criteria, and then deducing an ideal solution (Z( [symbol] )) from performances (Z(r*)) of said possible paths (r*) based on said criteria,
c) assign each possible path (r*) a value of interest (U(r)) allowing for said ideal solution (Z( [symbol] )), and then classifying said possible paths allowing for their respective values of interest, and
d) select from said classified possible paths the k best classified paths, in order to route data via one of said k paths.

21. A device according to claim 20, characterized in that said processing means are adapted to begin by determining from said multiplicity of nodes (Nn) all the pairs of nodes that can establish between them an oriented link each supporting at least one chosen local constraint, after which it is ensured that all the nodes of said pairs are connected.

22. A device according to claim 20, characterized in that said processing means are adapted to retain from said possible paths (r*) those that each satisfy at least one chosen global constraint so that values of interest (U(r)) are assigned to said retained possible paths (r*).

23. A device according to claim 20, characterized in that at least one of said criteria is of the non-additive type.

24. A device according to claim 23, characterized in that said processing means (M) are adapted to integrate into the computation of said possible paths (r*) a trace storing a route corresponding to a partial path, in order to detect and prevent cycles in the paths under construction.

25. A device according to claim 24, characterized in that said processing means (M) are adapted to retain solutions that are “weakly non-dominated” on the non-additive criterion during the procedure of eliminating said partial paths.

26. A device according to claim 1, characterized in that said processing means (M) are adapted to verify connectivity by a mechanism of propagation from the departure node (Ns) to all the other nodes (Nn) of said multiplicity of nodes, so that each node (Nn) is visited.

27. A device according to claim 20, characterized in that said processing means (M) are adapted to determine representative values (Z(r)) of its “performance” for each path with respect to each of said chosen criteria and to qualify as a possible path (r*) a path (r) for which said performance values (Z(r)) are “non-dominated”.

28. A device according to claim 27, characterized in that said processing means (M) are adapted to determine the best performance value (Z*(r)) observed over said possible paths, referred to as the “optimum value”, for each criterion, and then to construct said ideal solution (Z( [symbol] )) in the form of a multiplet of components constituted of the various optimum values thus determined.

29. A device according to claim 28, characterized in that said processing means (M) are adapted to assign to each possible path (r) a value of interest (U(r)) that characterizes the greatest value of the components associated with the various chosen criteria of a weighted Tchebychev function of differences between the performance of said possible path (r*) and the corresponding optimum value of said ideal solution (Z( [symbol] )).

30. A device according to claim 29, characterized in that said k possible paths (r*) retained have the k lowest values of interest (U(r)).

31. A device according to claim 21, characterized in that said local and/or global constraints are selected from a group comprising at least the minimum bandwidth required, the maximum length of the path, the number of hops on the path, at least one prohibited link, and a path color restriction.

32. A device according to claim 20, characterized in that said criteria are selected from a group comprising at least the available bandwidth (C2), the number of hops on the path (C3), and the duration of the path (C1).

33. A device according to claim 32, characterized in that said chosen criteria comprise the available bandwidth (C2) and the duration of the path (C1).

34. A device according to claim 33, characterized in that said processing means (M) are adapted to impact said criterion relating to the duration of the path (C1) by a penalty.

35. A device according to claim 34, characterized in that said penalty applies to the administration cost (CA) of the path.

36. A device according to claim 20, characterized in that said criteria are chosen as a function of the type of service required.

37. A device according to claim 20, characterized in that said chosen criteria are weighted as a function of their importance in the light of management information.

38. A device according to claim 21, characterized in that said constraints and their associated values are chosen as a function of the quality of service required.

39. Use of the method according to claim 1 in IP communication networks.

40. Use of the method according to claim 1 with link state routing protocols supporting TE-LSA traffic management.
